(19) United States
(12) Patent Application Publication
(10) Pub. No.: US 2021/0245713 A1
(43) Pub. Date: Aug. 12, 2021

(54) Wiper Device

(71) Applicant: CAP CORPORATION, Gyeongsangbuk-do (KR)

(72) Inventors: Tae Hun KIM, Daegu (KR); Myoung Yeon KIM, Ulsan (KR)

(21) Appl. No.: 17/076,712

(22) Filed: Oct. 21, 2020

(30) Foreign Application Priority Data
Feb. 10, 2020 (KR) 10-2020-0015784

(51) Int. Cl. B60S 1/04

(52) U.S. Cl. CPC B60S 1/0447

(57) ABSTRACT

A wiper device is disclosed, which includes: a contact member for wiping off foreign substances, a pressing member for pressing the contact member to be in tight contact with the windshield, an adapter that is coupled to the pressing member and has a connection recess formed therein to which an end portion of the wiper arm is inserted and connected, and an adapter cap that is coupled to the adapter and covers at least a portion of the connection recess, where the adapter cap includes: a cover part for covering an opening of the connection recess, a first coupler part that protrudes and extends from the cover part, is coupled to the adapter, and has a joint part formed to rotate the cover part in relation to the adapter, and a second coupler part that extends from the cover part and is coupled to the adapter.

### CROSS-REFERENCE TO RELATED APPLICATIONS

This application claims the benefit of Korean Patent Application No. 10-2020-0015784, filed with the Korean Intellectual Property Office on Feb. 10, 2020, the disclosure of which is incorporated herein by reference in its entirety.

### BACKGROUND

### 1. Technical Field

The present disclosure relates to a wiper device.

### 2. Description of the Related Art

Generally, when the windshield of a driven automobile becomes soiled by dust or other foreign substances floating in the air or by weather conditions such as snow and rain, such contamination may obstruct the field of vision of the driver and thus hinder safe driving. As such, automobiles are installed with an automobile wiper device for wiping off the snow, rain, or foreign substances from the windshield as a means for providing an unobstructed field of vision for safe driving. A wiper device may be connected to and operated by a wiper arm installed on the vehicle.

Wiper devices include a type in which the wiper arm is inserted into an adapted for connection, and with this type of wiper device, an adapter cap is coupled to the adapter as a finishing after the wiper arm is inserted.

FIG. 1 is a perspective view illustrating the adapter cap of a wiper device according to the related art.

As shown in FIG. 1, a conventional adapter cap 5 may generally be structured to be connected to the adapter 4 by a simple press fit. More specifically, the structure may involve the rotation shaft 4a of the adapter 4 being fitted into the connection recess 5a of the adapter cap 5 and the adapter cap 5 being rotated about the rotation shaft 4a.

However, the connection structure having the rotation shaft 4a fitted into the connection recess 5a provides a weak coupling force. Accordingly, problems involving the adapter cap 5 becoming separated from the adapter 4 by an external impact frequently occur.

### SUMMARY

The present disclosure aims to provide a wiper device that readily maintains the coupling of the wiper arm while preventing the adapter cap from becoming detached.

One aspect of the present disclosure provides a wiper device that is coupled to a wiper arm to remove foreign substances adhered to a windshield, where the wiper device includes: a contact member configured to wipe off the foreign substance, a pressing member configured to press the contact member such that the contact member is placed in tight contact with the windshield, an adapter that is coupled to the pressing member and has a connection recess formed therein to which an end portion of the wiper arm may be inserted and connected, and an adapter cap that is coupled to the adapter and covers at least a portion of the connection recess, and where the adapter cap includes: a cover part that covers an opening of the connection recess, a first coupler part that protrudes and extends from the cover part, is coupled to the adapter, and has a joint part formed thereon to rotate the cover part in relation to the adapter, and a second coupler part that extends from the cover part and is coupled to the adapter.

An embodiment of the present disclosure allows the adapter cap for covering the adapter to be firmly coupled to the adapter, effectively preventing the adapter cap from becoming separated during the operation of the wiper device.

Also, since the adapter cap has a rotatable structure, the inside of the adapter can be completely opened for easy coupling of the wiper arm.

### BRIEF DESCRIPTION OF THE DRAWINGS

FIG. 1 is a perspective view illustrating the adapter cap of a wiper device according to the related art.

FIG. 2 is a perspective view illustrating a wiper device according to an embodiment of the present disclosure.

FIG. 3 is an exploded view illustrating a wiper device according to an embodiment of the present disclosure.

FIG. 4 illustrates the adapter and adapter cap in a wiper device according to an embodiment of the present disclosure.

FIG. 5 and FIG. 6 provide more detailed illustrations of the adapter cap in a wiper device according to an embodiment of the present disclosure.

FIG. 7 illustrates the operation of an adapter cap in a wiper device according to an embodiment of the present disclosure.

FIG. 8 and FIG. 9 illustrate the coupling between the adapter and the adapter cap in a wiper device according to an embodiment of the present disclosure.

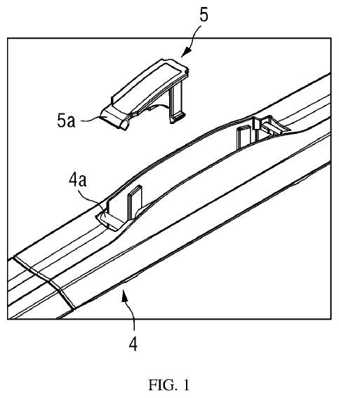

### DETAILED DESCRIPTION OF THE DISCLOSURE

Certain embodiments of the present disclosure are described below in further detail with reference to the accompanying drawings.

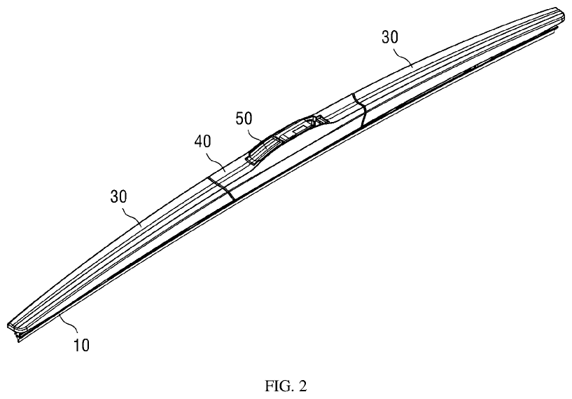

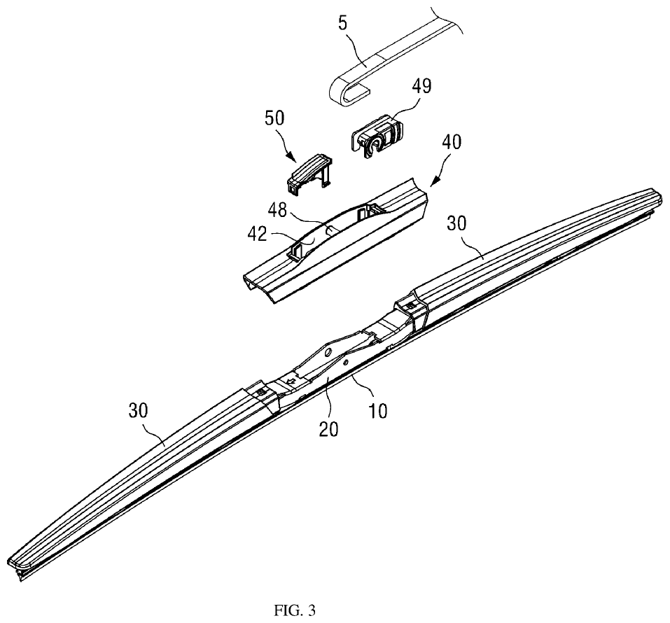

FIG. 2 is a perspective view illustrating a wiper device according to an embodiment of the present disclosure, and FIG. 3 is an exploded view illustrating a wiper device according to an embodiment of the present disclosure.

A wiper device according to an embodiment of the present disclosure may be a wiper device for removing foreign substances adhered to the windshield and may include a contact member 10, a pressing member 20, an adapter 40, and an adapter cap 50.

The contact member 10 may be the part that is placed in tight contact with the windshield to wipe off foreign substances, and a contact member 10 based on this embodiment may include any one of various known types of contact members such as a wiper blade made of a rubber material. A support member for elastically supporting the contact member 10 can be additionally coupled to the contact member 10.

The pressing member 20 may be the part that presses and supports the contact member 10 against the windshield such that the contact member 10 tightly contacts the windshield.

The pressing member 20 can include a tournament type lever structure in which multiple levers are connected by hinges. That is, the lever positioned closest to the wiper arm may be the uppermost lever, and multiple lower levers may sequentially be connected thereto, so that the lever structure extends towards the contact member 10.

The lever structure may be connected to the wiper arm 5 by way of the adapter 40 and may receive a pushing pressure transferred from the wiper arm 5. The pushing pressure transferred from the wire arm may be transferred to each connected lever, and the pushing pressure transferred to the levers may in turn be transferred to the contact member 10, whereby the contact member 10 can be pressed in tight contact against the curved surface of the vehicle windshield.

Also, the pressing member 20 can have a flat structure, for example made of a flat spring. The pressing member 20 can also have a hybrid structure in which a tournament structure and a flat structure are combined.

A cover member 30 that covers and protects the pressing member 20 can be coupled to the pressing member 20. The cover member 30 can have a spoiler function of receiving the force of the air and providing an additional pushing pressure on the lever structure.

Referring to FIG. 2 and FIG. 3, a wiper device based on this embodiment can include a pair of cover members 30, which may each be connected to either end portion of the adapter 40 to provide cover up to either end of the pressing member 20.

The adapter 40 may receive a force from the wiper arm 5 and transfer the force to the pressing member 20. To this end, the adapter 40 may be coupled to the pressing member 20 and may have the wiper arm 5 connected thereto. In the adapter 40, a connection recess 42 may be formed, to which an end portion of the wiper arm 5 may be inserted and connected.

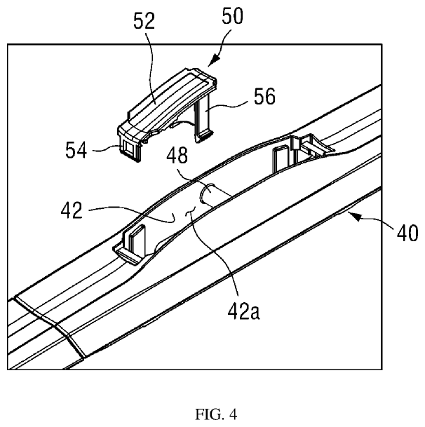

FIG. 4 illustrates the adapter and adapter cap in a wiper device according to an embodiment of the present disclosure.

Referring to FIG. 3 and FIG. 4, an adapter 40 based on this embodiment can be coupled to a center portion of the pressing member 20 and can have the wiper arm 5 inserted and connected inside through the connection recess 42.

For example, a connection rod 48 may be formed across the inside of the connection recess 42, and a wiper arm 5 having a U-shaped hook may be hooked and connected onto the connection rod 48. Here, a coupling member 49 that rotatably connects to the connection rod 48 can further be included, and the coupling member 49 can be fitted onto the U-shaped hook of the wiper arm 5.

The adapter cap 50 may serve to conceal the empty space of the connection recess 42 remaining after the wiper arm 5 is coupled. The adapter cap 50 may be coupled with the adapter 40 and may be structured to cover at least a portion of the connection recess 42.

More specifically, the adapter cap 50 may include a cover part 52, a first coupler part 54, and a second coupler part 56.

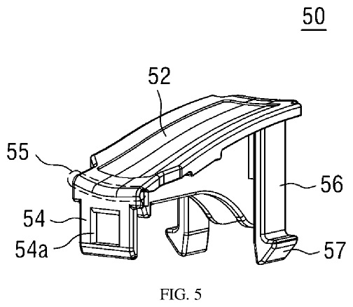

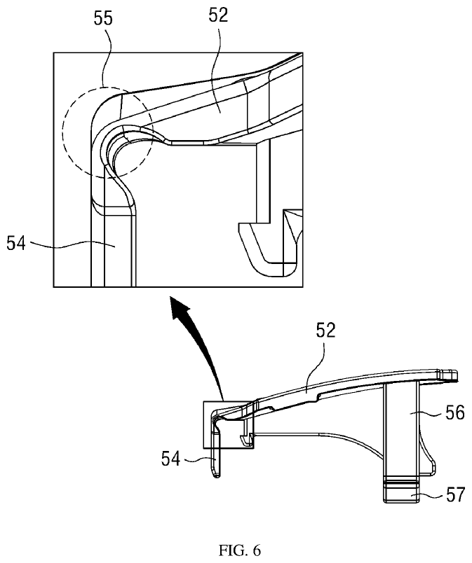

FIG. 5 and FIG. 6 provide more detailed illustrations of the adapter cap in a wiper device according to an embodiment of the present disclosure.

The cover part 52 may be the part that covers the opening 42a of the connection recess 42. The cover part 52 can cover the opening 42a, through which the wiper arm 5 may be inserted in the connection recess 42, whereby the cover part 52 can obscure the empty portions of the connection recess 42.

Referring to FIGS. 3 to 5, the cover part 52 can be a planar member and can cover the empty space of the connection recess 42 in front of the U-shaped hook of the wiper arm 5.

The first coupler part 54 may be the part that couples the adapter cap 50 to the adapter 40 as a rotatable structure. The first coupler part 54 may protrude and extend from the cover part 52 and may be coupled to the adapter 40, and on the first coupler part 54, a joint part 55 may be formed that rotates the cover part 52 in relation to the adapter 40.

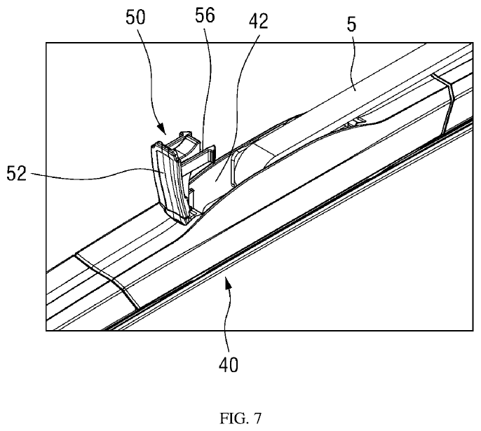

FIG. 7 illustrates the operation of an adapter cap in a wiper device according to an embodiment of the present disclosure.

Referring to FIG. 6 and FIG. 7, when the first coupler part 54 is coupled to the adapter 40, the cover part 52 can rotate about the joint part 55 to operate as a lid that opens and closes the connection recess 42. More specifically, the first coupler part 54 can be formed at the end portion on one side of the cover part 52, and the first coupler part 54 can be fitted and coupled to the inside of the connection recess 42 of the adapter 40. As a result, the joint part 55 of the first coupler part 54 positioned at the end portion on one side of the cover part 52 may serve as a hinge, and the cover part 52 can rotate around the joint part 55 to open and close the opening 42a of the connection recess 42.

Referring to FIG. 5 and FIG. 6, the cover part 52 and the first coupler part 5 can be made from a synthetic resin as an integrated body. Here, the joint part 55 can form an end portion of the first coupler part 54 extending from the cover part 52 and can be formed thinner than other portions of the first coupler part 54. As a result, the thinly formed joint part 55 may be capable of bending, and the cover part 52 may be capable of rotating about the joint part 55.

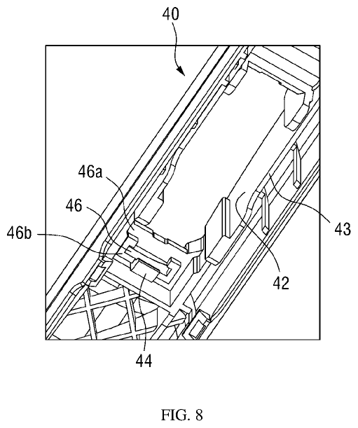

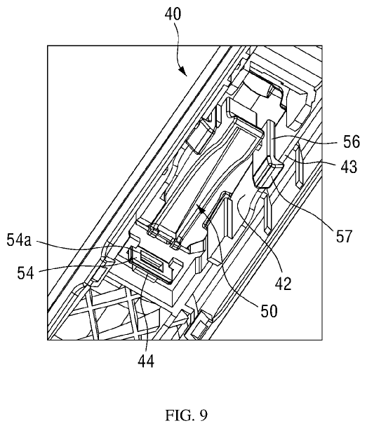

FIG. 8 and FIG. 9 illustrate the coupling between the adapter and the adapter cap in a wiper device according to an embodiment of the present disclosure.

Referring to FIGS. 5 to 9, a locking indentation 54a can be formed in the first coupler part 54, and a locking protrusion 44 of the adapter 40 can be fitted into the locking indentation 54a so that the first coupler part 54 may be secured and coupled to the adapter 40.

Referring to FIG. 8, in the adapter 40, a coupling hole 46 can be formed, to which the first coupler part 54 may be fitted, within the connection recess 42. For example, a partition 46a can be formed which traverses the connection recess 42 in a lateral direction such that a coupling hole 46 is formed at the end portion on one side (along the longitudinal direction) of the connection recess 42. Also, in order that the first coupler part 54 fitted into the coupling hole 46 may be firmly supported, a reinforcement part 46b can be formed to thicken the walls surrounding the coupling hole 46.

Referring to FIG. 8 and FIG. 9, on the adapter 40, a locking protrusion 44 can be formed, which may be coupled to the locking indentation 54a of the first coupler part 54 that has been inserted into the coupling hole 46. The locking protrusion 44 can be positioned under the coupling hole 46 within the connection recess 42. Thus, when the first coupler part 54 is passed through the coupling hole 46 and fitted, the locking protrusion 44 can be automatically inserted into the locking indentation 54a of the first coupler part 54 and coupled.

The second coupler part 56 may serve to secure the cover part 52 to the adapter 40. The second coupler part 56 may extend from the cover part 52 and may be coupled to the adapter 40. Accordingly, while the first coupler part 54 of the adapter cap 50 is coupled to the adapter 40 and the cover part 52 is in a rotatable state, when the second coupler part 56 is additionally coupled to the adapter 40, the cover part 52 can be secured to the adapter 40.

Referring to FIGS. 6 to 9, the second coupler part 56 can include a pair of arms extending from the cover part 52. The pair of arms can extend below the cover part 52 to be inserted into the connection recess 42 of the adapter 40. Also, the second coupler part 56 can include a fastening protrusion 57 that is formed at the end portion of each arm and latches onto the inner wall 43 of the adapter 40 to be fastened. Thus, when the cover part 52 covers the connection recess 42, the pair of arms can be inserted, and the fastening protrusions 57 can be fastened to the inner walls of the adapter 40.

As described above, a wiper device according to this embodiment can have the adapter cap 50 for covering the empty space in the connection recess 42 of the adapter 40 firmly coupled with the adapter 40, thereby effectively preventing any separation during operation of the wiper device. Also, since the adapter cap 50 has a structure that is rotatable about the joint part 55, the connection recess 42 can be completely opened during the coupling of the wiper arm 5.

While the foregoing provides a description of the present disclosure with reference to particular embodiments, those having ordinary skill in the relevant field of art would understand that numerous modifications and variations can be made to the present disclosure without departing from the spirit and scope of the present disclosure defined by the scope of claims set forth below.

Many embodiments other than those set forth above can be found in the appended claims.

### Description of Reference Numerals

5: wiper arm

10: contact member

20: pressing member

30: cover member

40: adapter

42: connection recess

44: locking protrusion

46: coupling hole

50: adapter cap

52: cover part

54: first coupler part

54a: locking indentation

55: joint part

56: second coupler part

57: fastening protrusion

What is claimed is:

1. A wiper device coupled to a wiper arm and configured to remove a foreign substance adhered to a windshield, the wiper device comprising:
a contact member configured to wipe off the foreign substance;
a pressing member configured to press the contact member such that the contact member is placed in tight contact with the windshield;
an adapter coupled to the pressing member and having a connection recess formed therein, the connection recess configured to have an end portion of the wiper arm inserted and connected thereto; and
an adapter cap coupled to the adapter and covering at least a portion of the connection recess,
wherein the adapter cap comprises:
a cover part covering an opening of the connection recess;
a first coupler part protruding and extending from the cover part and coupled to the adapter, the first coupler part having a joint part formed thereon, the joint part configured to rotate the cover part in relation to the adapter; and
a second coupler part extending from the cover part and coupled to the adapter.

2. The wiper device of claim 1, wherein the cover part and the first coupler part are made of a synthetic resin in a form of an integrated body,
and the joint part forms an end portion of the first coupler part extending from the cover part and is formed thinner than other portions of the first coupler part to be capable of bending.

3. The wiper device of claim 1, wherein the first coupler part has a locking indentation formed therein,
and the adapter comprises:
a coupling hole within the connection recess, the coupling hole configured to receive the first coupler part fitted therein; and
a locking protrusion configured to be inserted into the locking indentation of the first coupler part when the first coupler part is inserted into the coupling hole.

4. The wiper device of claim 1, wherein the second coupler part comprises a pair of arms extending from the cover part,
and a fastening protrusion is formed on an end portion of each arm, the fastening protrusion configured to latch onto an inner wall of the adapter for fastening.
